(19) United States
(12) Patent Application Publication
(10) Pub. No.: US 2026/0197585 A1
(43) Pub. Date: Jul. 9, 2026

(54) COMPUTER-IMPLEMENTED METHOD OF GENERATING AUDIO SIGNALS

(71) Applicant: Audioscenic Limited, Southampton (GB)

(72) Inventors: Marcos Simón, Southampton (GB); Jacob Hollebon, Southampton (GB); Daniel Wallace, Southampton (GB); Neil Crawshaw, Southampton (GB); Ben Scott, Southampton (GB); Filippo Fazi, Southampton (GB)

(21) Appl. No.: 19/440,108

(22) Filed: Jan. 5, 2026

(30) Foreign Application Priority Data
Jan. 6, 2025 (GB) 2500115.7

(51) Int. Cl. H04R 3/14; H04R 1/02; H04R 1/26

(52) U.S. Cl. CPC H04R 3/14; H04R 1/028; H04R 1/26; H04R 2499/11; H04R 2499/15

(57) ABSTRACT

There is disclosed a computer-implemented method of generating audio signals for an array of woofers and an array of tweeters housed in a computing device, the method comprising: receiving a plurality of input audio signals to be reproduced, by the array of woofers and the array of tweeters, at a respective plurality of control points in an acoustic environment; and generating a respective output audio signal for each of the woofers and tweeters by applying one or more cross-talk cancellation algorithms to the plurality of input audio signals to control a pressure at each of the plurality of control points, wherein the array of woofers consists of two woofers and the array of tweeters consists of at least three tweeters.

### RELATED APPLICATION

This application claims priority under 35 U.S.C. § 119 or 365 to Great Britain Application No. 2500115.7, filed Jan. 6, 2025. The entire teachings of the above application are incorporated herein by reference.

### TECHNICAL FIELD

The disclosure relates to a computer-implemented method of generating audio signals for example for a computing device such as a notebook or laptop.

### BACKGROUND

Generation of binaural audio signals, for 3D audio, may be provided through cross-talk cancellation. Cross-talk cancellation allows for the reproduction of binaural signals through loudspeakers. This is typically achieved by using a cross-talk cancellation algorithm. The algorithm facilitates the delivery of two signals at the listener's ears that are meant to match a desired binaural signal. This can be achieved by a system comprising of two loudspeakers, or through use of multichannel linear loudspeaker arrays comprising of more than two loudspeakers. The shift towards loudspeaker arrays is motivated by their proven robustness towards inaccuracies in the responses of the algorithms and also by their limited interaction with the room acoustics.

The use of multichannel miniature speaker arrays for reproduction of 3D audio through cross-talk cancellation in notebooks is described in Marcos F. Simon Gálvez et al. “A robustness study for low-channel-count cross-talk cancellation systems”; Audio Engineering Society Conference: 2019 AES Immersive and Interactive Audio Conference. July 2019. Additionally, systems for reproduction of 3D audio have been attempted in PC screens: Daniel Boothe et al. “Speaker driver arrangement for implementing cross-talk cancellation”. US2023077689A1. However, known approaches have provided sub-optimal performance over the full audible frequency range.

### SUMMARY

An invention is set out in the claims.

### BRIEF DESCRIPTION OF THE DRAWINGS

Examples of the present disclosure will now be explained with reference to the accompanying drawings in which:

FIG. 1 shows a top view of a computing device with a placement of woofers and tweeters in a proposed two-way system;

FIG. 2 shows operating frequency ranges of woofer and tweeter arrays;

FIG. 3 shows cross-talk cancellation performance of a combined system using a 2 channel downwards-firing woofer pair and a multichannel upwards-firing tweeter array;

FIG. 4 shows cross-talk cancellation performance of a pair of downwards-firing woofers comparing a large (outer) vs small (inner) spacing between the speakers;

FIG. 5 shows a side view of a laptop computing device and calculation of woofer and tweeters position with respect to a user's head based on a fixed laptop geometry and instantaneous head position detected by a listener-position sensing mechanism;

FIG. 6 shows cross-talk cancellation performance of a multichannel upwards-firing tweeter array vs a 2 channel downwards-firing woofer pair;

FIG. 7 shows a frequency response of a downwards-firing woofer and an upwards-firing tweeter;

FIG. 8 shows cross-talk cancellation performance of a multichannel downwards-firing woofer array vs a 2 channel downwards-firing woofer pair;

FIG. 9 shows a side view of a laptop design with down-firing woofers and front-firing tweeters for the multichannel array, where the woofers and the tweeters are at different heights;

FIG. 10 shows a front view of a laptop with down-firing woofers;

FIG. 11 shows a front view of a laptop with side-firing woofers;

FIG. 12 shows a side view of a laptop with front-firing woofers;

FIG. 13 shows a top view of placement of woofers and tweeters in an array system with shared array axis;

FIG. 14 shows a top view of placement of woofers and tweeters in an array system with different array axes (the woofers have a woofer array-axis and the tweeters have a tweeter array-axis);

FIG. 15 shows a flowchart of a method of generating audio signals; and

FIG. 16 shows an apparatus for generating audio signals which can be used to implement the method of FIG. 15.

### DETAILED DESCRIPTION

### Overview

In overview, a computer-implemented method of generating audio signals for a computing device is provided in which an array of a first and second woofer and an array of a greater number of tweeters than woofers is provided. For example, an array of L_{w}=2 woofers and an array of Lₜ>2 tweeters can be provided. A plurality of input audio signals is reproduced, by the arrays, at control points in an acoustic environment by applying a cross-talk cancellation algorithm.

In the field of audio reproduction systems for notebooks and laptops that use cross-talk cancellation for the reproduction of 3D sound, a 2-way loudspeaker system combining, for example, a 2 channel woofer array and a high frequency multi (greater than 2) channel tweeter array for cross-talk cancellation in a laptop form factor with minimum space footprint and high performance across the audible frequency range is thus achieved. In particular, while multichannel loudspeaker arrays require multiple loudspeakers, in a laptop form factor this is difficult to achieve as it requires a large amount of space to fit the loudspeakers and cabinets. However, by using a woofer and multichannel tweeter combination in the manner disclosed, it is possible to provide acceptable cross-talk cancellation for high-performance 3D audio reproduction over the entire frequency spectrum, whilst at the same time minimising the loudspeaker volume footprint required by the driver-cabinet loudspeaker modules. The loudspeaker arrangement can thus be optimised based on the audio reproduction algorithm used. For example, for cross-talk cancellation low frequency control requires large loudspeaker spacings, whilst high frequency control requires small loudspeaker spacings, both of which can be achieved in the disclosed arrangement.

### Context

In general terms, the present disclosure relates to a computer-implemented method of generating audio signals for example for a computing device such as a notebook or laptop.

Some audio systems provide 3D spatial audio of an audio programme, for example, video or video game audio content. To generate the 3D audio, the audio systems may provide binaural audio signals that are used to drive speakers, such as loudspeakers. Loudspeakers may include one or more speaker drivers. Cross-talk may occur when the sound from one set of speaker drivers interferes (or mixes) with another set of speaker drivers that are at a separate position. To avoid this, a cross-talk cancellation (CTC) algorithm may be applied on the audio to provide 3D spatial audio with minimised cross-talk.

CTC makes the reproduction of binaural audio possible through loudspeakers. This is typically achieved by employing a digital signal processing network that, through creating specific loudspeaker signals, controls the acoustic pressure at the listener's ears to minimise cross-talk. Although this can be achieved by using only two loudspeakers, there has been a recent tendency of using loudspeaker arrays, which increase the robustness to source errors and reduce the room's response influence.

The effectiveness of the CTC algorithm is influenced by the arrangement (and/or number) of speaker drivers that are integrated within an audio device. As the spacing of built-in speakers increases for larger audio devices, the effectiveness of the sweet spot may change at different frequencies, where the sweet spot is the area where the intended audio is focused and received by the user most effectively. As spacing between speaker drivers increases, the sweet spot for lower frequencies (for example, below 1 kHz) may provide sufficient spatialization, whereas the size of the sweet spot for higher frequencies (for example, above 1 kHz) may be reduced. To avoid this problem, a multichannel array of high-range speaker drivers (tweeters) that output high-frequency audio and an array of low-range speaker drivers (woofers) that output low-frequency audio may be used. The array of tweeters and array of woofers receive the input audio signals to be reproduced at respective control points in an acoustic environment and generate a respective output audio signal for each of the woofers and tweeters by applying the CTC algorithm to the input audio signals to control the pressure at the control points.

The details of how such CTC algorithms work are described, for example, in EP3920557 and will be well known to the skilled reader, but are summarised briefly here. Listener-adaptive based CTC 3D audio systems may rely on multiple control filters to generate the sound driving one or more loudspeakers. The parameters of these filters are adapted in real-time according to the instantaneous position of one or more listeners, which is estimated with a listener tracking device (for example, a camera, global positioning system device, or wearable device). This filter parameter adaptation requires expensive computational resources, thus making the use of such audio reproduction approaches difficult for small embedded devices. Part of the computational resource consumption comes from the need for multiple inverse filters, which follows from the use of complex, accurate transfer function models between the system loudspeakers and the ears of a given listener.

Listener-adaptive CTC systems can be based on stereo loudspeaker arrangements. Listener-adaptive systems can also use arrangements of multichannel arrays of loudspeakers. These listener-adaptive CTC system examples may use time-varying signal-processing control approaches in order to adapt to time-varying listener positions and head orientations. The control filters may be read from a database, or calculated on the fly at significant computational cost. CTC-based 3D audio systems have an improved response when more than two loudspeakers are used.

The technology is also described in WO 2017/158338 A1, which allows for processing-efficient listener-adaptive audio reproduction with loudspeaker arrays using more than two loudspeakers. The main CPU overhead (or consumption) reduction introduced by the technology results from decomposing the filtering signal processing audio flow into a combination of loudspeaker-dependent filters (DF) and loudspeaker-independent filters (IF). In the technology, the IFs are implemented as a set of time-varying finite impulse response (FIR) filters, whilst the DFs are implemented as a set of time-varying gain-delay elements. Due to this decomposition, only M×M control filters and M delay lines with L reading points each are needed, where M is the number of acoustic pressure control points (normally one for each of the listeners' ears) and L the number of loudspeakers of the loudspeaker array. The CTC algorithm requires that the acoustic transfer function between each loudspeaker and the acoustic pressure control points be representable with linear phase and frequency independent gains, for example, assuming a free-field point-monopole propagation model.

### Cross-Talk Cancellation Approach

A CTC algorithm may be implemented via a controller which executes a computer implemented method with the below steps.

First, a plurality of input audio signals to be reproduced are received, by the array of woofers and the array of tweeters, at a respective plurality of control points (or listening positions such as the user's ears) in an acoustic environment. The control points may be received using a position sensor. In particular, the position of each of the control points may be received or determined.

Respective output audio for each of the woofers and tweeters may be generated by applying one or more CTC algorithms to the plurality of input audio signals to control the pressure at a plurality of M control points (generally referred to herein as control points). The algorithm may be applied in the frequency domain. In this case, a transform, such as a fast Fourier transform (FFT), is applied to the input audio signals, the algorithm is applied, and an inverse transform is then applied to obtain the output audio signals.

The CTC algorithm may be based on filters derived from an approximation of a respective transfer function for each of the control points and woofers and tweeters, the respective transfer function being between an audio signal applied to a respective one of the woofers or tweeters and an audio signal received at a respective one of the control points from the respective one of the woofers or tweeters. The CTC may be also based on a predetermined position and/or a predetermined orientation of each of the woofers and tweeters and a received estimate of the position of each of the plurality of control points.

The estimate of the position of each of the plurality of control points is with respect to a reference point, and the cross-talk cancellation algorithm is further based on a predetermined position of each of the woofers and tweeters with respect to the reference point.

The CTC algorithm may be applied with a different set of parameters with the same steps but based on a different estimation of each of the plurality of control points.

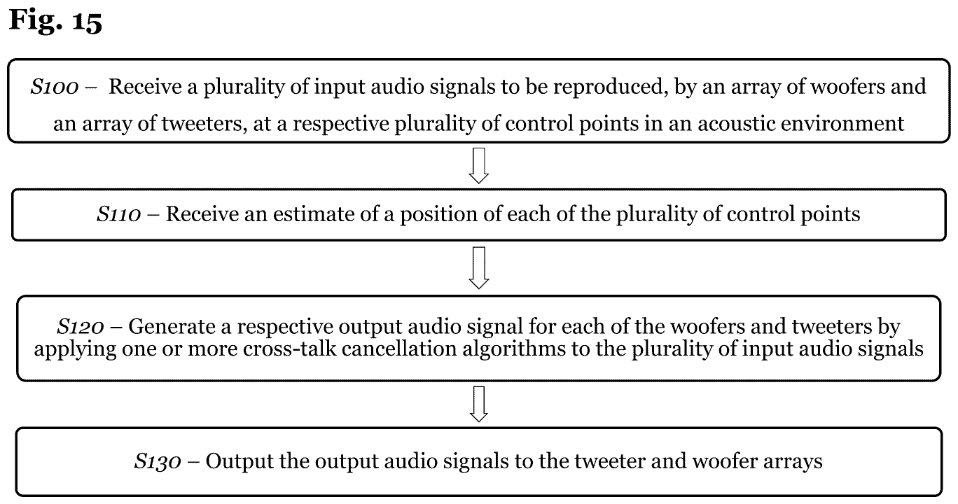

Other features of the method are described below with reference to FIG. 15.

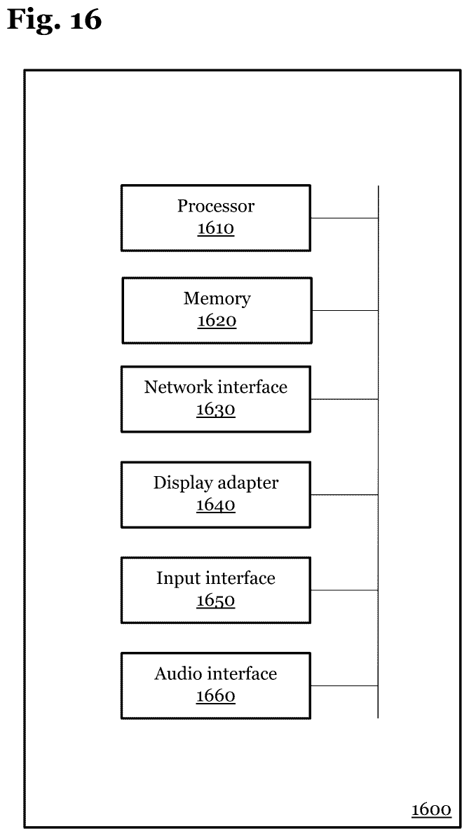

An exemplary computing device for implementing any of the methods described herein, may comprise a computer program, a sound reproduction apparatus, a controller, the array of woofers and array of tweeters and a housing with the woofers and tweeters. The controller is configured to output the respective output audio signals for the woofers to the array of woofers and the respective output audio signals for the tweeters to the array of tweeters, and to implement the method. The apparatus is described in more detail below, in ‘Example implementations’, and below with reference to FIG. 16 in ‘Alternative implementations’.

### Illustrative Designs

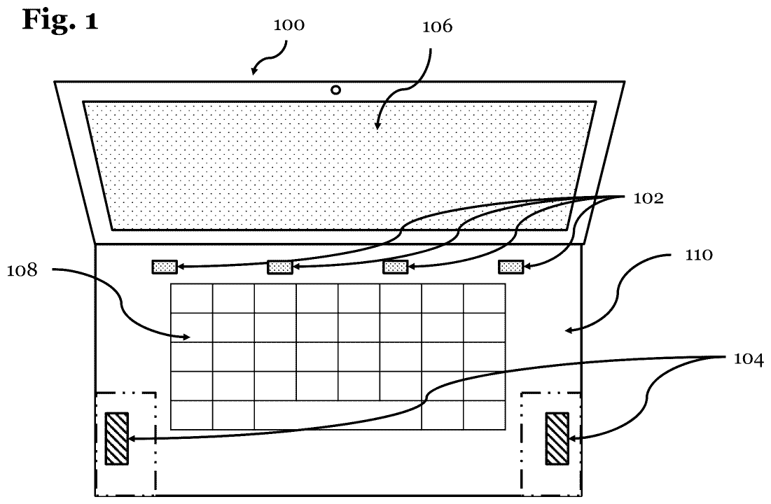

An example system combining 2 woofers and a multichannel tweeter array can be seen in FIG. 1. In the figure, a diagrammatic representation of a laptop 100 is shown with a set of 2 woofers 104 and a multi-channel tweeter array consisting of more than 2 tweeters 102.

In the embodiment shown it can be seen that a 4 channel or loudspeaker array of tweeters 102 is provided in a line parallel to the long axis of the laptop base 110, on the upper surface and along the rear edge of the base 110, that is, behind the keyboard 108 and adjacent and below the screen 106. The tweeters 102 are rectangular in shape, with their long axes aligned with the long axis of the laptop base 110. In addition, two woofers 104 are provided at the front of the base 110, that is, in front of the keyboard 108, at opposite corners. The woofers 104 are rectangular in shape with their long axes perpendicular to the long axis of the laptop base 110. In the embodiment shown the woofers 104 are provided on the undersurface of the base 104, but in other embodiments the woofers 104 can be provided on the upper surface as discussed in more detail below. Further still, as CTC algorithms control the acoustic interference between drivers, it is therefore preferable that the path between loudspeaker and listener's ears is not obstructed, for example by the hand of the listener. The arrangement shown satisfies this requirement. Note that the disposition of the tweeter array here is exemplary, and that the tweeter array could also be placed on the underside of the lid of the laptop and below the laptop screen 106, or inside the keyboard 108. More generally, any layout of the tweeters 102 can be adopted, of regular or irregular spacing and orientation, and in any desired position, and the CTC algorithms can be implemented accordingly.

The arrangement further takes into account that CTC is achieved with a combination of constructive wave interference, achieved with beamforming, and destructive interference. The former is more robust to errors and can be increased by increasing the number of drivers, whereas the latter is sensitive to modeling errors. These errors are likely to be more severe at high frequencies (especially because of loudspeaker directivity and acoustic diffraction). It is therefore preferable to maximise the constructive/beamforming CTC at high frequency. Both effects are achieved at high frequency by the proposed arrangement, which includes a larger number of closely-spaced, high-frequency drivers (tweeters 102). Additionally, tweeters 102 have minimum volume requirements and multiple tweeters 102 can be more easily accommodated in a laptop 100 form factor than multiple woofers 104/full range loudspeakers.

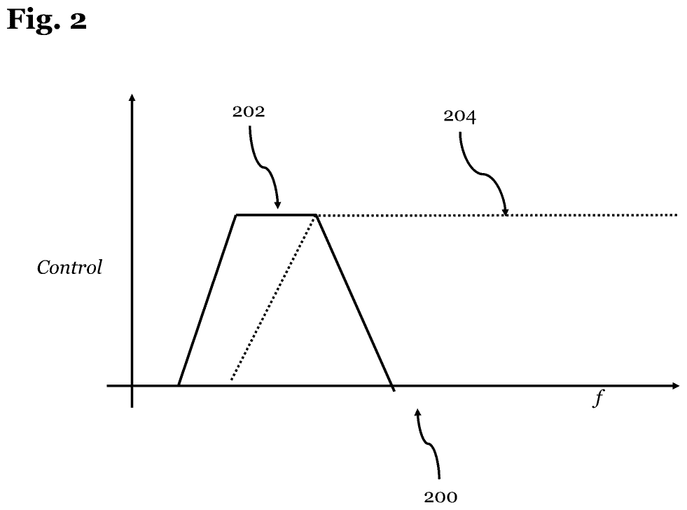

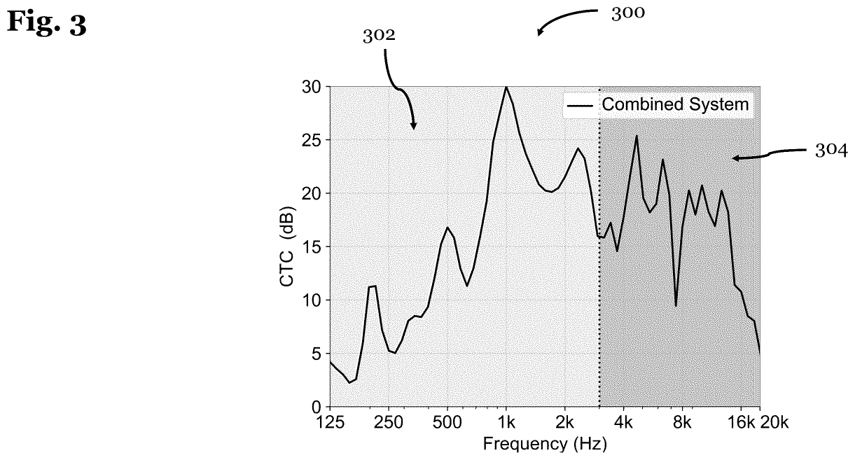

Shown in FIG. 2 is a 2-way design. A set of 2 woofers is used for cross-talk cancellation at low frequencies. The low-frequency loudspeakers are able to excite sound at a low-frequency range 202 with higher dynamic range than a full range loudspeaker, therefore, it is desired to employ woofers just for the treatment and delivery of the low-frequency part of the spectrum. As can be seen in FIG. 3, the CTC response 300, described in more detail below, thus achieves an acceptable level across the audible spectrum. The 2-way design (that is, separation of tweeters and woofers) achieves this as shown in FIG. 3. As a set of 2 woofers is used for cross-talk cancellation at low frequencies they are able to excite sound at a low-frequency range 302 with higher dynamic range than a full range loudspeaker. Therefore, it is desired to employ woofers just for the treatment and delivery of the low-frequency part of the spectrum, whereas the high-frequency component 304 is provided by the tweeters.

FIG. 3 shows in more detail the response 300 primarily provided by the woofers in the low frequency range (shaded light grey 302) and in the high frequency range (shaded darker grey 304) by the tweeters. In particular, the combination of 2 woofers and a multichannel tweeter array can provide high cross-talk cancellation ensuring the CTC level remains above 10 dB at all relevant frequencies, whilst requiring a minimum volume footprint for the loudspeaker's enclosures and also optimising the frequency response of the entire system at the listener's ears without the need for significant corrective equalization (EQ). This is additionally relevant in new artificial intelligence (AI) laptop designs, where large batteries are required and little space is left for extra loudspeakers.

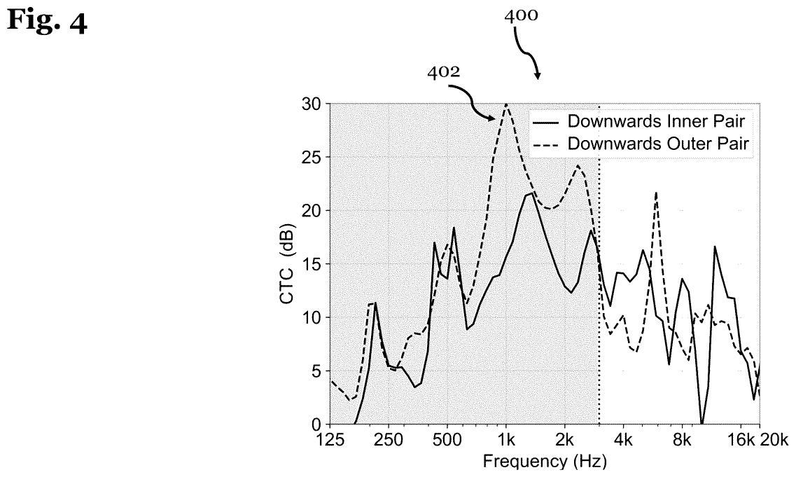

Although any appropriate spacing can be adopted, to provide enhanced low frequency performance of the cross-talk cancellation system, the pair of woofers are preferably spaced widely; the performance of CTC at low frequencies can be maximised if the distance between drivers is as large as possible. This reduces the required amount of destructive wave interference and allows for a higher dynamic range in the speaker drivers. In FIG. 4, a comparison is made between two pairs of woofers using different speaker spacings, where outer corresponds to the outer pair of the array (spacing of 28 cm corresponding to a normal sized laptop) versus an inner pair (spacing of 10 cm). This shows that reducing the spacing leads to a drop in the achievable cross-talk cancellation level at low frequencies below 3000 Hz 402. Preferably, therefore, the 2 woofers are spaced as widely as possible given the limitations of the physical laptop, that is to say at opposite edges of the laptop relative to the long axis of the laptop base, for example less than 8 centimetres from an edge (in the long direction) of a housing of the computing device, and/or at least 10 centimetres from each other. Other arrangements are possible, for example, the woofers 104 can be placed at opposing diagonal corners on the top or bottom surfaces (or one on either surface) of the laptop base for even greater spacing.

In operation, the woofer 104 and tweeter 102 loudspeaker audio system described works using listener-position adaptive audio DSP software to provide user-position adaptive 3D audio, using techniques that are well known to the skilled reader but which will be summarised briefly here. Both woofers 104 and tweeters 102 are controlled by software that takes into account that the array of 2-woofers and the array of multiple tweeters may share a different array axis, i.e., may be placed at different distances to the user's head. The axes may be separated both by the length of the laptop base 110 along its short axis and/or by the height of the laptop base 110 if the woofers 104 are positioned on the underside, as shown in FIG. 1.

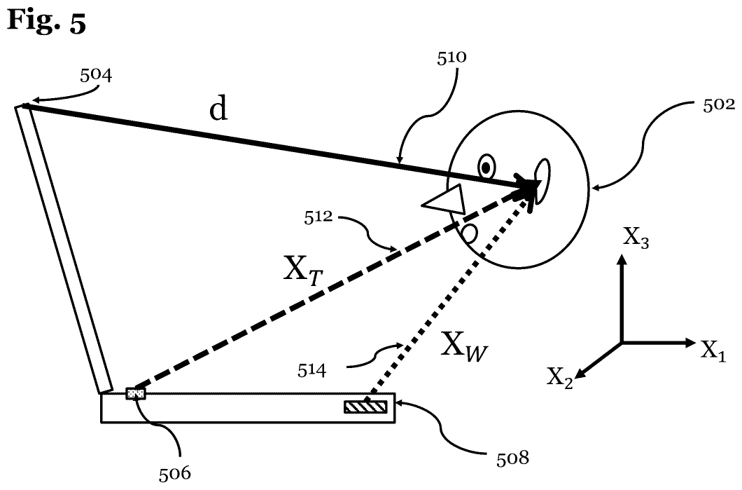

Referring to FIG. 5, the distances between the elements of the 2 woofer array and the tweeter array are fixed because of the laptop geometry, while the exact position of the user head 502 is estimated via listener-position sensing software (for example, using the laptop's webcam 504 or other sensors placed in the laptop), so that the exact position between the user's head and the various loudspeakers is known at all times. An example of this real-time estimation is shown in FIG. 5, where a three-dimensional vector of listener head position 510 d is obtained in real time. The listener head position vector d can be estimated using a listener-position sensing mechanism based on the laptop's webcam 504 or in another sensor based in the laptop. For reference, in FIG. 5 the listener-position sensing mechanism is placed on top of the laptop bezel, but it could be placed somewhere else along the laptop. Any appropriate position estimation system can be adopted as will be well known to the skilled reader, taking into account the exact locations of the speaker arrays as discussed above. Alternatively, the position of the listener's head can be estimated based on known typical user positioning data to provide a fixed, non-adaptive implementation.

Once the position of the user is known, and given the fixed relationship of the loudspeaker elements in the laptop, a series of geometrical transformations is used to determine the relative position of each loudspeaker with respect to the listener 502 (or listener's ears), obtaining individual vectors of all the tweeter positions X_{T} 512 and woofer positions X_{W} 514 relative to the listener 502. Note here X_{T,W} contains the positions in 3D of all the tweeters 506/woofers 508 respectively. These individual three dimensional vectors of position are then used as input to a cross-talk cancellation algorithm that calculates digital signal processing filters in real-time according to the instantaneous user positions, as known to the skilled reader and described in, for example, EP3920557 and GB2616073.

The three-dimensional vectors of loudspeaker positions X_{W} 514 and X_{T} 512 are then used as the input to a cross-talk cancellation algorithm. The loudspeaker positions denoted by the position vectors can then be used to retrieve loudspeaker to ear transfer functions that form the plant matrix, as defined in GB2616073, which is used to create the cross-talk cancellation filters.

Examples of loudspeaker to ear transfer functions are head-related transfer functions. In this case, head-related transfer functions can be derived for each element of the 2-woofer array and for the multi-tweeter array to each of the ears of a user at the given position with respect to the laptop device.

The loudspeaker to ear transfer functions can be loaded from a database storing head-related transfer functions which have been measured for predefined positions, can be modelled using acoustic delay and gain elements or can be generated using mathematical models, as will be well known to the skilled reader.

To assess the frequency response for the loudspeaker arrays, the capabilities for 3D audio rendering of cross-talk cancellation systems is typically measured by means of the cross-talk cancellation level. The cross-talk cancellation level (CTC) is the absolute squared pressure difference of the signals that are delivered to both ears (LEFT and RIGHT) of a user listening to a CTC device averaged over two specific test signals (10 and 01), which consist of reproducing a target signal of a Dirac impulse in the left ear only (10) or right ear only (01). This is defined in Eq 1.

$$CTC = 10 {log}_{10} [ \frac{1}{2} ( \frac{{\vert {p}_{left , 10} \vert}^{2}}{{\vert {p}_{right , 10} \vert}^{2}} + \frac{{\vert {p}_{right , 01} \vert}^{2}}{{\vert {p}_{left , 01} \vert}^{2}} ) ] \qquad ( 1 )$$

In order to deliver 3D audio by binaural reproduction through speakers, it is preferred that a cross-talk cancellation capable system obtains a CTC level that is higher than 10 dB between 300 Hz to 8 kHz. This will yield sufficient 3D audio performance and good spatial audio localisation. A CTC level lower than 10 dB within this frequency range will give inaccurate localisation and a poor spatial audio performance.

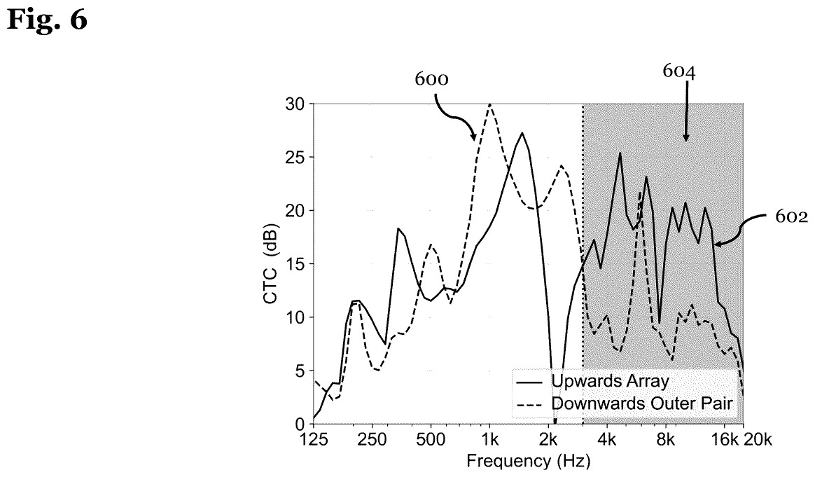

As shown in FIG. 3, the hardware design described herein achieves a large CTC level over the frequency range of interest. This can be understood in more detail with reference to FIGS. 6 to 8. FIG. 6 shows the cross-talk cancellation level for the downwards-firing outer pair 600 of woofers 104 shown in FIG. 1 compared to an upwards-firing 5 channel array 602 of tweeters 102. This shows that, above 3 kHz, in the grey shaded region 604, the tweeter array 102 performs significantly better than the 2 channel downwards-firing woofer pair 104. This demonstrates that a particular benefit of using an array of a comparatively larger number of speakers in a laptop form factor is at high frequencies, and thus can consist of tweeters 102 to save space and orientated as upwards-firing drivers to ensure appropriate reconstruction of high frequencies.

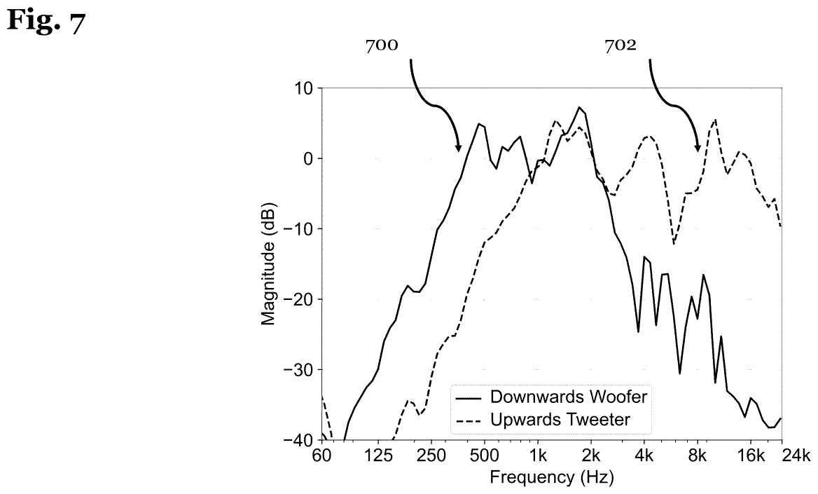

A measurement of a typical downwards-firing woofer 700 and upwards-firing tweeter 702 is shown in FIG. 7, which demonstrates how, above 1.8 kHz, the woofer response significantly rolls off. From this plot and an analysis of a number of different woofer types and designs, a possible appropriate operating range of downwards-firing woofers in laptops is approximately up to 1-4 kHz. The tweeter loudspeaker exhibits a higher resonance frequency which means it is less useful for low frequency content, however it retains a much better response at high frequencies. The starting operating frequency of a typical upwards-firing tweeter on a laptop is from 1 kHz.

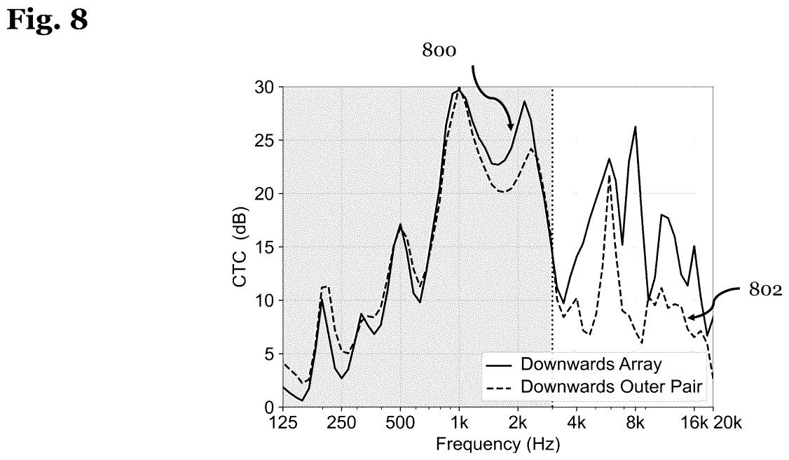

FIG. 8 shows the cross-talk cancellation performance of two systems in combination, a 5 channel downwards-firing woofer array situated at the front of a laptop 800, and a 2 channel downwards-firing woofer pair using the same width of the array 802. Cross-talk cancellation level is a measure of the spatial performance of a system. The 2 channel pair performs identically up till 1 kHz, and very similarly between 1-3 kHz. The region of acceptable matched performance is shown shaded in grey. Although above 3 kHz the multi-channel woofer array can provide better spatial performance (high cross-talk cancellation level) due to the presence of more loudspeakers which are closer spaced, this indicates that the multi-channel woofer array is not a necessity below 1-3 kHz, where a pair of woofers can be used effectively, with a crossover frequency between the low frequency pair and a high frequency array in the range 1-4 kHz. Woofers typically require a large cabinet volume in order to provide good frequency response. Therefore, reducing the number of required woofers, or full-range drivers, from 5 to 2 introduces many space saving advantages which then can be used by other important notebook components.

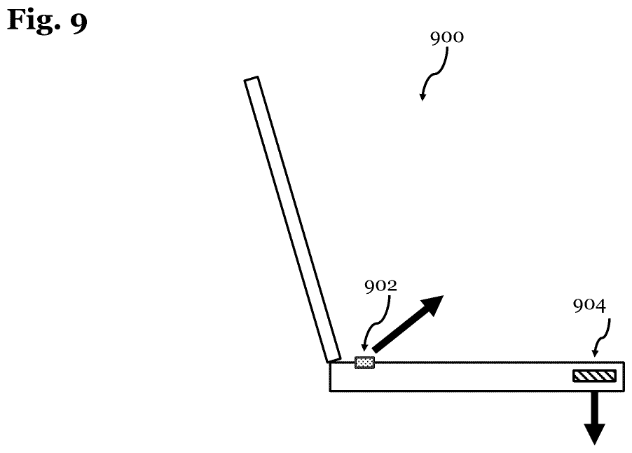

FIG. 9 shows in more detail how the woofers and tweeters are orientated in the laptop design 900, taking into account the response shown in FIGS. 6 to 8, when pairing downward-firing woofers 904 with upwards-firing tweeters 902. Sometimes low frequency woofers/full range speakers are orientated on a laptop downwards or towards the side or sideways (as discussed below in relation to FIG. 11) due to space constraints but these exhibit a significant high frequency roll-off in their frequency response as they are not orientated towards the listener. At mid to high frequencies this complicates modeling the loudspeaker acoustic interference required to perform CTC. Using upwards-firing tweeters 902 in this scenario is simpler to model, leading to better performance of the CTC algorithm, and the use of multiple loudspeakers improves the performance of the CTC at higher frequencies.

It will be noted that use of a comparatively smaller number of woofers mitigates the problem that a large amount of real-space is required to fit the multiple woofer cabinets, especially as in laptops physical real-space is very much sought after for different sets of components. This is because apart from the space for the loudspeaker driver, loudspeakers come in a module of driver plus cabinet, and typically the cabinets require a few cubic centimetres of volume that make each module bulky with respect to the total available space in a laptop. The addition of the loudspeaker enclosure raises the loudspeaker's resonant frequency, which in turn reduces the bass response of the loudspeaker. Therefore, for low-frequency woofers, larger enclosures are required than for high-frequency tweeters. This in turn means a multi-channel array of woofers takes up a considerably larger amount of space than the equivalent number of tweeters. Tweeters may have smaller enclosures and smaller physical drive units due to the optimisation of the loudspeaker to only reproduce high frequencies.

Another issue with using a larger number array of full-range or woofer loudspeakers is the orientation of the loudspeakers. Sometimes, to fit such large loudspeakers within the laptop enclosure, the vent of the loudspeaker enclosure is orientated downwards, towards the surface the laptop rests on, or alternatively the vent is orientated sideways. This is because the top surface of the laptop base is covered with other components such as the trackpad and keyboard. To fit an array of full-range/woofer loudspeakers with vents oriented upwards would reduce the top surface space even more than the currently accepted 2 channel designs for laptops. As discussed above, if the loudspeakers are orientated downwards this affects the frequency response of the loudspeakers at the listener's ears, causing a significant high frequency roll-off. Whilst this may be compensated to some extent with equalisation (EQ), this design can cause issues with cross-talk cancellation where accurate knowledge of the acoustic transfer functions from the loudspeakers to the listener's ears is required. The tweeters are more practical to fit in within the design of the laptop base top surface as they are physically much smaller due to their optimization for reproducing high frequency only.

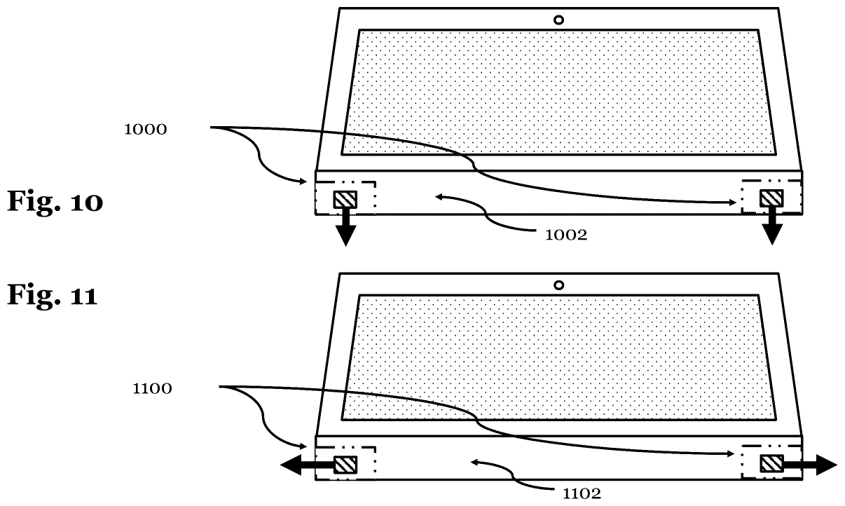

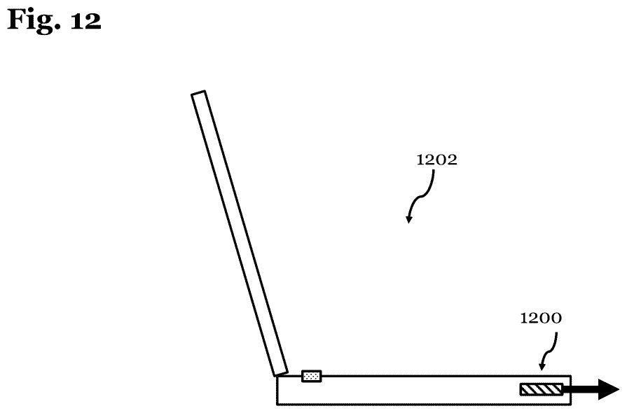

In an embodiment, speakers can be located on an upper- or downward-facing surface of the base, or on a lateral edge, such as the front, rear or side edge. For example, the 2 woofers 1000 are placed on the underside of the laptop base 1002, near the front lateral edge, in a down-firing configuration in FIG. 10. In another embodiment shown in FIG. 11, the woofers can be placed on the side edge of the laptop base 1102, near the front lateral edge, but in a side-firing configuration 1100, to minimise interference of occlusion of the loudspeaker transfer functions by the users' hands. In another embodiment shown in FIG. 12, the woofers can be placed on the front lateral edge of the laptop base 1202 and front-firing perpendicular to the laptop front edge 1200. It will be apparent to the skilled reader that the woofers can also be placed in other configurations not described here. For example, woofers can also be placed at the lateral front edges of the laptop and output sound facing the user. The woofer elements can be constituted of a single loudspeaker driver, or can be built using more than one driver, as for example using a back-to-back type of woofer element construction of the type well known to the skilled reader.

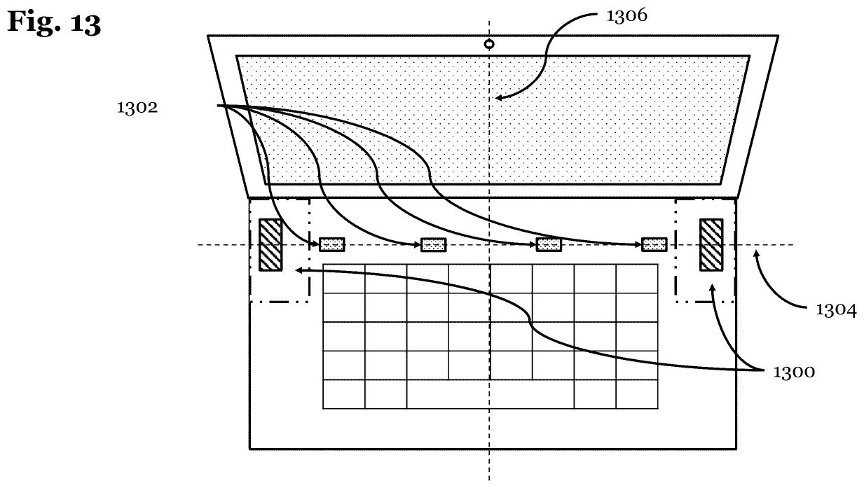

The line which dissects the positions of all the array elements (woofers 1300 or tweeters 1302) is defined as an array axis 1304. As shown in FIG. 13, the 2 channel woofer pair are placed along a ‘woofer array axis’ defined as parallel to the laptop screen, at some distance along the laptop body. Similarly, the tweeter array loudspeakers are placed along a ‘tweeter array axis’ which is also parallel to the laptop screen. That is, each of the woofer/tweeter arrays 1300 1302 follow a linear geometry respectively. Note the speakers are arranged symmetrically in the embodiment shown, that is, the speakers are symmetric about the sagittal plane (central line dissecting the laptop 1306), thereby providing improved CTC performance. In the embodiment shown in FIG. 13, the woofer array 1300 and the tweeter array 1302 share the same array axis 1304. It will be apparent to the skilled reader that the woofers and tweeters can also be placed in other configurations not described here in which the woofers and tweeters are not symmetrically arranged with respect to the sagittal plane, thereby providing more flexible placement of components of the computing device.

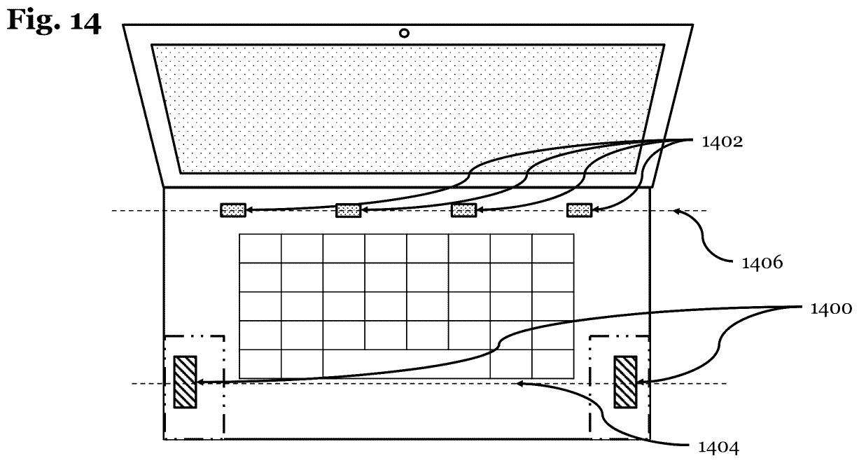

In the embodiment described with reference to FIG. 1 and shown in more detail in FIG. 14, the woofers 1400 and tweeters 1402 are placed in different locations, for example, because of space constraints in the laptop. This causes the woofer array 1400 to have its own array axis, the woofer array axis 1404, and the tweeter array 1402 to have its own array axis, the tweeter array axis 1406. The physical position of the different axes can be taken into account differently by the cross-talk cancellation system, and it will be noted that any desired geometrical configuration can be accommodated by appropriate CTC modelling. In particular, where each array has a different centre of coordinates, this needs to be taken into consideration when finding the relative array position when this is derived from the listener position sensing system, and needs to be treated appropriately by the cross-talk cancellation algorithm when calculating real-time parameters.

While the embodiments are presented in relation to laptops, it will be noted that the approach of the present disclosure can be implemented in any appropriate computing device, for example, a notebook, tablet or other computing device or peripheral having a fixed physical layout, especially in instances where there are space constraints. Any particular form of speaker, and geometry of layout, can be adopted within the space constraints of the device, and any appropriate CTC algorithm can be implemented, which can be the same for each array or with different cross-talk algorithms for different frequency ranges, as will be apparent to the skilled reader.

The proposed approach therefore combines a loudspeaker system that can provide effective cross-talk cancellation over a required frequency range of utilisation to provide accurate 3D audio reproduction, and packages this with minimised physical footprint. This makes possible the adoption of this technology in laptop platforms which do not have enough available space to fit a multichannel loudspeaker array of woofers or full-range loudspeakers.

### Alternative Implementations

It will be appreciated that the above approaches and designs can be implemented in many ways. There follows a general description of features which may be common to many implementations of the above approaches and designs. It will of course be understood that, unless indicated otherwise, any of the features of the above approaches and designs may be combined with any of the common features listed below.

There is provided a computer-implemented method of generating audio signals for an array of woofers and an array of tweeters.

A ‘woofer’ may be a speaker driver configured to reproduce audio in a first frequency range, and a ‘tweeter’ may be a speaker driver configured to reproduce audio in a second frequency range, where a lower end of the first frequency range is lower than a lower end of the second frequency range and an upper end of the second frequency range is higher than an upper end of the first frequency range.

The array of woofers and array of tweeters may be housed in a computing device, such as the computing device of FIG. 1, 5, or 9 to 14.

Selected steps of the method are illustrated in FIG. 15.

The method comprises, at step S100, receiving a plurality of input audio signals. A respective one of the plurality of input audio signals may be to be reproduced, by the array of woofers and the array of tweeters, at each of a plurality of control points (or ‘listening positions’) in an acoustic environment (or ‘acoustic space’).

Each of the plurality of input audio signals may be different.

At least one of the plurality of input audio signals may be different from at least one other one of the plurality of input audio signals.

The method may further comprise, at step S110, receiving an estimate of a position of each of the plurality of control points.

The plurality of control points may be locations of a corresponding plurality of listeners.

The plurality of control points may be locations of ears of one or more listeners.

The method may further comprise, prior to step S110, determining the plurality of control points using a position sensor.

The method further comprises, at step S120, generating (or ‘determining’) a respective output audio signal for each of the woofers and tweeters by applying one or more cross-talk cancellation algorithms to the plurality of input audio signals to control a pressure at each of the plurality of control points.

The array of woofers may consist of two woofers. The array of tweeters may consist of at least three tweeters. This provides a balance between speaker footprint and system performance.

The generating may comprise generating the respective output audio signal for each of the woofers by applying a first cross-talk cancellation algorithm to the plurality of input audio signals, and generating the respective output audio signal for each of the tweeters by applying a second cross-talk cancellation algorithm to the plurality of input audio signals.

The first and second cross-talk cancellation algorithms may be the same, or may be different.

The cross-talk cancellation algorithm may generate the output audio signals such that, when the output audio signals are fed to the array of woofers and the array of tweeters, substantially only the respective one of the plurality of input audio signals is reproduced at each of the plurality of control points.

Applying the one or more cross-talk cancellation algorithms may comprise applying a set of cross-talk cancellation filters. The set of cross-talk cancellation filters may be digital filters. The set of cross-talk cancellation filters may be applied in the frequency domain. The set of cross-talk cancellation filters may be based on a plurality of filter elements comprising a respective filter element for each of the control points and loudspeakers.

A filter element may be a weight of a filter. A plurality of filter elements may be any set of filter weights. A filter element may be any component of a weight of a filter. A plurality of filter elements may be a plurality of components of respective weights of a filter.

The set of cross-talk cancellation filters may be time-varying. Alternatively, the set of cross-talk cancellation filters may be fixed or time-invariant, e.g., when listener positions and head orientations are considered to be relatively static.

The one or more cross-talk cancellation algorithms or the set of cross-talk cancellation filters may be based on an approximation of a respective transfer function for each of the control points and woofers and tweeters, the respective transfer function being between an audio signal applied to a respective one of the woofers or tweeters and an audio signal received at a respective one of the control points from the respective one of the woofers or tweeters.

The approximation may be based on a free-field acoustic propagation model and/or a point-source acoustic propagation model. The approximation may account for one or more of reflections, refraction, diffraction or scattering of sound in the acoustic environment. The approximation may alternatively or additionally account for scattering from a head of one or more listeners. The approximation may alternatively or additionally account for one or more of a frequency response of each of the loudspeakers or a directivity pattern of each of the loudspeakers. The approximation may be based on one or more head-related transfer functions, HRTFs. The one or more HRTFs may be measured HRTFs. The one or more HRTFs may be simulated HRTFs. The one or more HRTFs may be determined using a boundary element model of a head.

The one or more cross-talk cancellation algorithms or the set of cross-talk cancellation filters may be based on a predetermined position and/or a predetermined orientation of each of the woofers and tweeters. As a result, the output audio signals generated by the method may be a function of the position and/or orientation of each of the woofers and tweeters within the computing device.

The one or more cross-talk cancellation algorithms or the set of cross-talk cancellation filters may be based on the received estimate of the position of each of the plurality of control points.

The estimate of the position of each of the plurality of control points may be with respect to a reference point, and the one or more cross-talk cancellation algorithms or the set of cross-talk cancellation filters may further be based on a predetermined position of each of the woofers and tweeters with respect to the reference point.

Generating the respective output audio signals may comprise using a filter bank to apply at least the one or more crosstalk cancellation algorithms or the set of cross-talk cancellation filters in a plurality of frequency subbands, e.g., one subband for the woofers and one for the tweeters.

The generating of the respective output audio signal for each of the woofers and tweeters may be based on a crossover frequency of 1 kHz to 4 kHz.

The method may further comprise, prior to step S120, receiving the set of cross-talk cancellation filters, e.g., from another processing device, or from a filter determining module. The method may further comprise, prior to step S120, determining the set of cross-talk cancellation filters.

The method may further comprise, at step S130, outputting the output audio signals to the tweeter and woofer arrays.

The method may be repeated. In other words, the estimate of the position of each of the plurality of control points may be received at a first time, the one or more cross-talk cancellation algorithms applied in the generating may be based on a first set of cross-talk cancellation algorithm parameters, and the method may further comprise: at a second time, receiving an estimate of the position of each of the plurality of control points; and repeating the generating by applying the one or more cross-talk cancellation algorithms based on a second set of cross-talk cancellation algorithm parameters, the second set of cross-talk cancellation algorithm parameters being based on the received estimate of the position of each of the plurality of control points at the second time.

The woofers may face away from an underside of the computing device (as shown, for example, in FIG. 9). In other words, the woofers may be downward-firing or downward-facing. The woofers may be disposed on the underside of the computing device.

The woofers may face away from a respective lateral side of the computing device (as shown, for example, in FIG. 11). In other words, the woofers may be side-firing or side-facing. The woofers may be disposed on the respective lateral side of the computing device.

The woofers may face away from a front edge of the computing device (as shown, for example, in FIG. 12). The woofers may be disposed on the front edge of the computing device.

The tweeters may face away from an upper side of the computing device (as shown, for example, in FIG. 9). In other words, the tweeters may be upward-firing or upward-facing. The tweeters may be disposed on the upper side of the computing device. In particular, the tweeters may face away from an upper side of a base of the computing device. The tweeters may be disposed on the upper side of the base of the computing device.

The woofers and tweeters may face opposite sides of the computing device (as shown, for example, in FIG. 9).

The woofers may be positioned at opposite edges of the computing device (as shown, for example, in FIGS. 10 and 11).

Each of the woofers may be positioned less than 8 centimetres from an edge of a housing of the computing device.

Each of the woofers may be positioned at a respective distance from an edge of a housing of the computing device, the respective distance being less than 30% of a width of a viewable display area of the computing device or less than 30% of a width of the housing.

The woofers may be positioned at least 10 centimetres from each other.

The woofers may be spaced apart by a distance of at least 35% of a width of a viewable display area of the computing device or at least 35% of a width of a housing of the computing device.

The array of woofers and the array of tweeters may be linear arrays.

The woofers and tweeters may be positioned along a same axis (as shown, for example, in FIG. 13).

The woofers and tweeters may be positioned along different axes (as shown, for example, in FIG. 14).

The woofers and/or tweeters may be arranged symmetrically (i.e., substantially symmetrically) with respect to a central latitudinal axis of the computing device (as shown, for example, in FIGS. 13 and 14).

The woofers and/or tweeters may be arranged asymmetrically with respect to a central latitudinal axis of the computing device (as shown, for example, in FIGS. 13 and 14).

Each of the woofers may comprise a plurality of drivers.

There is provided an apparatus, in particular, a controller for a computing device, configured to perform any of the methods described herein.

The apparatus or controller may comprise a processor or digital signal processor configured to perform any of the methods described herein.

The apparatus may be coupled, or may be configured to be coupled, to the array of woofers and the array of tweeters.

There is provided a computer program comprising instructions which, when executed by a controller, cause the controller to perform any of the methods described herein.

There is provided a data carrier signal comprising instructions which, when executed by a controller, cause the controller to perform any of the methods described herein.

There is provided a (non-transitory) computer-readable medium or a data carrier signal comprising the computer program.

There is provided a sound reproduction apparatus for a computing device comprising the controller, the array of woofers, and the array of tweeters.

The controller may be configured to output the respective output audio signals for the woofers to the array of woofers and the respective output audio signals for the tweeters to the array of tweeters.

There is provided a computing device comprising a housing and, within the housing, the controller or the sound reproduction apparatus.

The computing device may be a mobile device.

The computing device may further comprise, within the housing, a rechargeable energy storage device configured to power the processor.

The computing device may be a laptop computer or tablet computer.

### Controller Implementation

A block diagram of an exemplary apparatus 1600 for implementing any of the methods described herein, such as the method of FIG. 15, is shown in FIG. 16. The apparatus 1600 may be used to implement at least a portion of the controller, and by extension at least a portion of the sound reproduction apparatus and/or the computing device.

The apparatus 1600 may comprise a processor 1610 (e.g., a digital signal processor) arranged to execute computer-readable instructions as may be provided to the apparatus 1600 via one or more of a memory 1620, a network interface 1630, or an input interface 1650.

The memory 1620, for example a random-access memory (RAM), is arranged to be able to retrieve, store, and provide to the processor 1610, instructions and data that have been stored in the memory 1620. The network interface 1630 is arranged to enable the processor 1610 to communicate with a communications network, such as the Internet. The input interface 1650 is arranged to receive user inputs provided via an input device (not shown) such as a mouse, a keyboard, or a touchscreen. The processor 1610 may further be coupled to a display adapter 1640, which is in turn coupled to a display device (not shown). The processor 1610 may further be coupled to an audio interface 1660 which may be used to output audio signals to one or more audio devices, such as a loudspeaker array. The audio interface 1660 may comprise a digital-to-analog converter (DAC) (not shown), e.g., for use with audio devices with analog input(s).

In some implementations, the various methods described above are implemented by a computer program. In some implementations, the computer program includes computer code arranged to instruct a computer to perform the functions of one or more of the various methods described above. In some implementations, the computer program and/or the code for performing such methods is provided to an apparatus, such as a computer, on one or more computer-readable media or, more generally, a computer program product. The computer-readable media is transitory or non-transitory. The one or more computer-readable media could be, for example, an electronic, magnetic, optical, electromagnetic, infrared, or semiconductor system, or a propagation medium for data transmission, for example for downloading the code over the Internet. Alternatively, the one or more computer-readable media could take the form of one or more physical computer-readable media such as semiconductor or solid state memory, magnetic tape, a removable computer diskette, a random access memory (RAM), a read-only memory (ROM), a rigid magnetic disc, or an optical disk, such as a CD-ROM, CD-R/W or DVD.

In an implementation, the modules, components and other features described herein are implemented as discrete components or integrated in the functionality of hardware components such as ASICS, FPGAs, DSPs or similar devices.

A ‘hardware component’ is a tangible (e.g., non-transitory) physical component (e.g., a set of one or more processors) capable of performing certain operations and configured or arranged in a certain physical manner. In some implementations, a hardware component includes dedicated circuitry or logic that is permanently configured to perform certain operations. In some implementations, a hardware component is or includes a special-purpose processor, such as a field programmable gate array (FPGA) or an ASIC. In some implementations, a hardware component also includes programmable logic or circuitry that is temporarily configured by software to perform certain operations.

Accordingly, the term ‘hardware component’ should be understood to encompass a tangible entity that is physically constructed, permanently configured (e.g., hardwired), or temporarily configured (e.g., programmed) to operate in a certain manner or to perform certain operations described herein.

In addition, in some implementations, the modules and components are implemented as firmware or functional circuitry within hardware devices. Further, in some implementations, the modules and components are implemented in any combination of hardware devices and software components, or only in software (e.g., code stored or otherwise embodied in a machine-readable medium or in a transmission medium).

### Interpretation

Section titles are provided above to ease understanding of the disclosure, and are not to be construed as limiting the scope of the disclosure.

Unless otherwise indicated, the orientations and positions set out in the present disclosure assume that the computing device (e.g., laptop) rests on a horizontal supporting surface, that the user of the computing device is using the computing device in its default physical operating configuration (e.g., for a laptop, the lid is open and the user is facing the laptop approximately as shown in FIG. 5), and that, if there is a choice of device orientation (e.g., for a tablet computer), the device is in landscape orientation. Accordingly:
terms such as ‘upwards’, ‘upward-facing’, ‘top-facing’, or ‘upward-firing’ refer to a direction facing away from the supporting surface, i.e., substantially in direction X₃ as shown in FIG. 5;
terms such as ‘downwards’, ‘downward-facing’, ‘bottom-facing’, ‘bottom-firing’, or ‘downward-firing’ refer to a direction facing towards the supporting surface, i.e., substantially in the opposite direction to direction X₃ in FIG. 5;
terms such as ‘frontwards’, ‘front-facing’ or ‘front-firing’ refer to a direction substantially parallel to the supporting surface and towards the user, i.e., substantially in direction X₁ as shown in FIG. 5;
the term ‘front’ refers to the side of the computing device that is closest to the user (e.g., for a laptop, the side nearest the trackpad);
the terms ‘back’ or ‘rear’ refer to the side of the laptop that is furthest from the user (e.g., for a laptop, the side nearest the hinge);
the terms ‘underside’ or ‘bottom surface’ refer to the surface that is closest to, and substantially parallel to, the supporting surface; and
the terms ‘top side’ or ‘top surface’ refer to the surface that is furthest from, and substantially parallel to, the supporting surface (e.g., for a laptop, the surface upon which the keyboard is disposed).

It will be appreciated that, although various approaches above may be implicitly or explicitly described as ‘optimal’, engineering involves tradeoffs and so an approach which is optimal from one perspective may not be optimal from another. Furthermore, approaches which are slightly sub-optimal may nevertheless be useful. As a result, both optimal and sub-optimal solutions should be considered as being within the scope of the present disclosure.

Those skilled in the art will recognise that a wide variety of modifications, alterations, and combinations can be made with respect to the above described examples without departing from the scope of the disclosed concepts, and that such modifications, alterations, and combinations are to be viewed as being within the scope of the present disclosure.

Those skilled in the art will also recognise that the scope of the invention is not limited by the examples described herein, but is instead defined by the appended claims.

What is claimed is:

1. A computer-implemented method of generating audio signals for an array of woofers and an array of tweeters housed in a computing device, the method comprising:
receiving a plurality of input audio signals to be reproduced, by the array of woofers and the array of tweeters, at a respective plurality of control points in an acoustic environment; and
generating a respective output audio signal for each of the woofers and tweeters by applying one or more cross-talk cancellation algorithms to the plurality of input audio signals to control a pressure at each of the plurality of control points,
wherein the array of woofers consists of two woofers and the array of tweeters consists of at least three tweeters.

2. The method of claim 1, wherein the generating comprises:
generating the respective output audio signal for each of the woofers by applying a first cross-talk cancellation algorithm to the plurality of input audio signals; and
generating the respective output audio signal for each of the tweeters by applying a second cross-talk cancellation algorithm to the plurality of input audio signals.

3. The method of claim 1, wherein:
the woofers face away from an underside of the computing device; or
the woofers face away from a respective lateral side of the computing device, optionally wherein the woofers face away from a front edge of the computing device.

4. The method of claim 1, wherein at least one of:
the tweeters face away from an upper side of the computing device;
the woofers and tweeters face opposite sides of the computing device; or
the woofers are positioned at opposite edges of the computing device, optionally wherein each of the woofers is positioned less than 8 centimetres from an edge of a housing of the computing device, and/or optionally wherein the woofers are positioned at least 10 centimetres from each other.

5. The method of claim 1, wherein the array of woofers and the array of tweeters are linear arrays, optionally wherein the woofers and tweeters are positioned along a same axis, or optionally wherein the woofers and tweeters are positioned along different axes.

6. The method of claim 1, wherein the woofers and tweeters are arranged symmetrically with respect to a central latitudinal axis of the computing device.

7. The method of claim 1, wherein at least one of:
each of the woofers comprises a plurality of drivers;
the generating of the respective output audio signal for each of the woofers and tweeters is based on a crossover frequency of 1 kHz to 4 kHz;
the one or more cross-talk cancellation algorithms are based on an approximation of a respective transfer function for each of the control points and woofers and tweeters, the respective transfer function being between an audio signal applied to a respective one of the woofers or tweeters and an audio signal received at a respective one of the control points from the respective one of the woofers or tweeters; or
the one or more cross-talk cancellation algorithms are based on a predetermined position and/or a predetermined orientation of each of the woofers and tweeters.

8. The method of claim 1, further comprising:
receiving, optionally from a position sensor on the computing device, an estimate of a position of each of the plurality of control points,
wherein the one or more cross-talk cancellation algorithms are based on the received estimate of the position of each of the plurality of control points.

9. The method of claim 8, wherein the estimate of the position of each of the plurality of control points is with respect to a reference point, and wherein the one or more cross-talk cancellation algorithms are further based on a predetermined position of each of the woofers and tweeters with respect to the reference point.

10. The method of claim 8, wherein the estimate of the position of each of the plurality of control points is received at a first time, the one or more cross-talk cancellation algorithms applied in the generating are based on a first set of cross-talk cancellation algorithm parameters, and the method further comprises:
at a second time, receiving an estimate of the position of each of the plurality of control points; and
repeating the generating by applying the one or more cross-talk cancellation algorithms based on a second set of cross-talk cancellation algorithm parameters, the second set of cross-talk cancellation algorithm parameters being based on the received estimate of the position of each of the plurality of control points at the second time.

11. A controller for a computing device, the controller being configured to perform a method of generating audio signals for an array of woofers and an array of tweeters housed in the computing device, the method comprising:
receiving a plurality of input audio signals to be reproduced, by the array of woofers and the array of tweeters, at a respective plurality of control points in an acoustic environment; and
generating a respective output audio signal for each of the woofers and tweeters by applying one or more cross-talk cancellation algorithms to the plurality of input audio signals to control a pressure at each of the plurality of control points,
wherein the array of woofers consists of two woofers and the array of tweeters consists of at least three tweeters.

12. A non-transitory computer-readable medium comprising instructions which, when executed by a controller, cause the controller to perform a method of generating audio signals for an array of woofers and an array of tweeters housed in the computing device, the method comprising:
receiving a plurality of input audio signals to be reproduced, by the array of woofers and the array of tweeters, at a respective plurality of control points in an acoustic environment; and
generating a respective output audio signal for each of the woofers and tweeters by applying one or more cross-talk cancellation algorithms to the plurality of input audio signals to control a pressure at each of the plurality of control points,
wherein the array of woofers consists of two woofers and the array of tweeters consists of at least three tweeters.

13. A sound reproduction apparatus for a computing device, comprising:
the controller of claim 11;
the array of woofers; and
the array of tweeters,
wherein the controller is configured to output the respective output audio signals for the woofers to the array of woofers and the respective output audio signals for the tweeters to the array of tweeters.

14. A computing device comprising a housing and, within the housing, the controller of claim 11.

15. A computing device comprising a housing and, within the housing, the sound reproduction apparatus of claim 13.

16. The method of claim 1, wherein the computing device is a mobile device, optionally a laptop computer or tablet computer.

17. The controller of claim 11, wherein the computing device is a mobile device, optionally a laptop computer or tablet computer.

18. The sound reproduction apparatus of claim 13, wherein the computing device is a mobile device, optionally a laptop computer or tablet computer.

19. The computing device of claim 14, wherein the computing device is a mobile device, optionally a laptop computer or tablet computer.
